(19) United States
(12) Patent Application Publication
(10) Pub. No.: US 2013/0066753 A1
(43) Pub. Date: Mar. 14, 2013

(54) METHODS, APPARATUSES, AND SYSTEMS RELATING TO INVENTORY SHARING NETWORKS

(71) Applicants: Douglas H. Doyle, Wilson, WY (US); Brian D. McGee, Jackson, WY (US)

(72) Inventors: Douglas H. Doyle, Wilson, WY (US); Brian D. McGee, Jackson, WY (US)

(73) Assignee: B2B SALESLINK, LLC, Wilson, WY (US)

(21) Appl. No.: 13/232,791

(22) Filed: Sep. 14, 2011

(51) Int. Cl. G06Q 10/08

(52) U.S. Cl. 705/28

(57) ABSTRACT

An inventory sharing network includes a manufacturer of a plurality of manufacturer's products and a plurality of authorized merchants that are independently owned and operated from the manufacturer as a non-exclusive seller of products. The inventory sharing network is controlled by the manufacturer, who may select the plurality of authorized merchants that are authorized to participate in an inventory sharing network and select the key products that may be offered by the authorized merchants within the inventory sharing network. The inventory sharing network may be implemented by an e-commerce platform stored on an access server that manages access to an inventory sharing database and display of related information.

### TECHNICAL FIELD

Embodiments of the present invention are generally directed to the retail product distribution, and more specifically, to inventory sharing networks.

### BACKGROUND

In today's retail market place dictated by tight manufacturing, merchants (i.e., retailers) essentially have one opportunity to execute their season's stock (i.e., inventory). Merchants typically purchase their inventory from manufacturers for sale to their customers. At the beginning of the season, merchants attempt to predict the amount of inventory they expect to sell during the season in order to determine the quantity of products to purchase from the manufacturer. At the end of the season, excess inventory is a sunk cost that may reduce the profits received from sold inventory if excess inventory remains at the end of the season. As a result, excess inventory is often discounted to entice customers to purchase the products to reduce at least some of the losses. Having insufficient inventory ordered at the beginning of the season may result in lost sales opportunities and potentially unhappy customers.

One type of conventional inventory sharing networks is known in terms of “virtual” inventory systems in which merchants list (usually on-line) products for sale that the merchant does not actually have in inventory. Such inventory sharing networks may permit merchants to post products on other merchant's website, and have other merchants post their products on their website. As a result, each merchant can offer a wider variety of products without having to undertake the high acquisition costs of the having a very diverse product line. Upon purchase of a product by a customer, the merchant can obtain the product from a member of the virtual inventory sharing network, or have the product shipped to the customer directly from the other participating merchant who has the purchased product.

Another type of conventional inventory sharing network is known that permits merchants to establish inventory sharing networks among each other. The inventors have appreciated that such inventory sharing networks typically lack the involvement of the manufacturer, particularly when merchants are non-exclusive merchants of the manufacturer. The inventors have also appreciated that in many situations where contractual obligations exist between the non-exclusive merchant and the manufacturer, many merchants would be prohibited from joining conventional inventory sharing networks as merchants may not be allowed to purchase a manufacturer's products from third parties. The inventors have further appreciated that inventory sharing networks that do not include the manufacturer generally limit valuable information to the manufacturer. Conventional inventory sharing networks that do involve a manufacturer are generally limited to internal networks set up among exclusive merchants of the manufacturer that are often owned and operated by the manufacturer.

### BRIEF DESCRIPTION OF THE SEVERAL VIEWS OF THE DRAWINGS

While the specification concludes with claims particularly pointing out and distinctly claiming that which is regarded as the present disclosure, the advantages of this disclosure may be more readily ascertained from the description of embodiments of the disclosure when read in conjunction with the accompanying drawings, in which:

FIG. 1A is a block diagram of a generic inventory sharing network according to an embodiment of the present disclosure;

FIG. 1B is a schematic block diagram of an e-commerce system implementing the inventory sharing network of FIG. 1A;

FIGS. 2A, 2B, and 2C offer more specific examples of inventory sharing networks, and an e-commerce system than those of FIGS. 1A and 1B;

FIG. 3 shows a log-in screen that may be used to gain access to an access server and interact with the inventory sharing networks of FIGS. 2A, 2B, and 2C;

FIG. 4 shows an introduction screen that shows examples of different areas that users may have access to view or edit;

FIG. 5 shows a manufacturer screen that may be accessible to a user when the user is classified as a manufacturer;

FIG. 6 shows an authorized merchant screen that may be accessible to a user when the user is classified as an authorized merchant;

FIG. 7 shows a product screen that may be accessible to a user when the user is classified as an authorized merchant;

FIG. 8 shows an order screen that may be accessible to a user when the user desires to purchase a product from one of the authorized merchants of the inventory sharing network;

FIG. 9 is a purchase log screen that may be accessible to authorized merchants to view the status of purchases they have made; and

FIG. 10 is a transaction log screen that may include transaction information of transactions executed through the e-commerce system.

### DETAILED DESCRIPTION

In the following description, reference is made to the accompanying drawings in which is shown, by way of illustration, specific embodiments of the present disclosure. The embodiments are intended to describe aspects of the disclosure in sufficient detail to enable those skilled in the art to practice the invention. Other embodiments may be utilized and changes may be made without departing from the scope of the disclosure. The following detailed description is not to be taken in a limiting sense, and the scope of the present invention is defined only by the appended claims.

Furthermore, specific implementations shown and described are only examples and should not be construed as the only way to implement or partition the present disclosure into functional elements unless specified otherwise herein. It will be readily apparent to one of ordinary skill in the art that the various embodiments of the present disclosure may be practiced by numerous other partitioning solutions.

In the following description, elements, circuits, and functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general-purpose processor, a special-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A general-purpose processor may be considered a special-purpose processor while the general-purpose processor executes instructions (e.g., software code) stored on a computer-readable medium. A processor may also be implemented as a combination of computing devices, such as a combination of a DSP and a microprocessor, a plurality of microprocessors, one or more microprocessors in conjunction with a DSP core, or any other such configuration.

Also, it is noted that the embodiments may be described in terms of a process that may be depicted as a flowchart, a flow diagram, a structure diagram, or a block diagram. Although a process may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on computer readable media. Computer-readable media includes both computer storage media and communication media including any medium that facilitates transfer of a computer program from one place to another.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

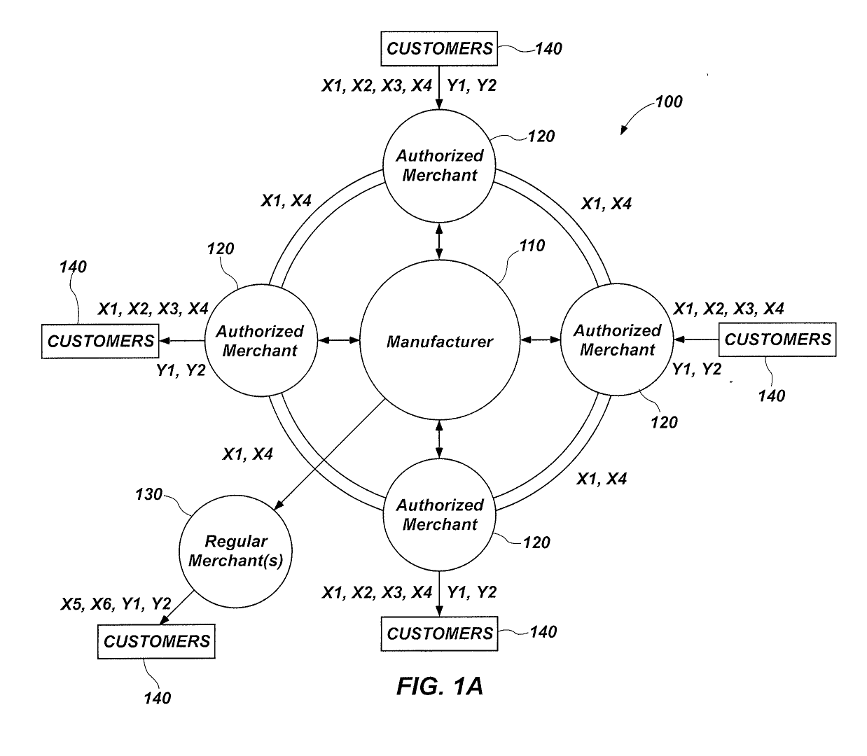

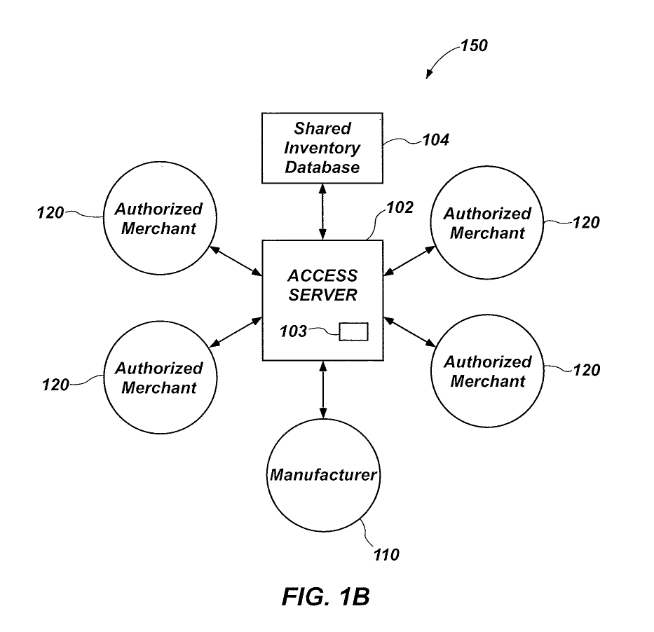

FIG. 1A is a block diagram of a generic inventory sharing network 100 according to an embodiment of the present disclosure. The inventory sharing network 100 includes a manufacturer 110 and a plurality of authorized merchants 120 of the manufacturer 110. As will be described in more detail below, the manufacturer 110 may control the inventory sharing network 100 for its products. For example, the manufacturer 110 may permit the authorized merchants 120 to join the inventory sharing network 100 and share inventory between each other under the terms of the contracts in place with the manufacturer 110 and the authorized merchants 120. As a result, the inventory sharing network 100 may link manufacturers 110 and their authorized merchants 120 to an expanded inventory network. The inventory sharing network 100 may be implemented with an e-commerce platform that is accessible by the manufacturer 110 and the plurality of authorized merchants 120.

As used herein, the term “inventory sharing” refers to offering an inventory item (i.e., good, product, etc.) for sale to other authorized merchants 120 in a business to business (B2B) setting, and potentially selling the inventory item to another authorized merchant 120 in the inventory sharing network 100. An “inventory sharing transaction” is a B2B transaction executed through the inventory sharing network 100. In other words, a sale of a product to a regular customer 140 (e.g., the ultimate end user) is not an inventory sharing transaction.

As used herein, and despite any conventional usage of the term, a “manufacturer” refers to an entity that provides a merchant with a product. The manufacturer 110 may be the originator (i.e., brand company) of the product, and may include the producer (i.e., maker) of the product. Thus, for convenience, the term “manufacturer” is used in the examples below to be interpreted broadly to mean the originator of the product, the maker of the product, and product provider. It is recognized that these functions may not be performed by the same entity, but may be performed by multiple entities in concert.

For example, while the term manufacturer 110 is used throughout the example embodiments described herein, the manufacturer 110 may refer to other entities that are approved to act for the manufacturer 110, such as a distributor, supplier, etc. Thus, in some embodiments, while the manufacturer 110 is intended to indicate an ultimate originator of a product, but it is also intended that others associated with the manufacturer 110 that establish an inventory sharing network should also be considered a “manufacturer” as defined herein, unless specifically described to the contrary. In other words, a supplier should be considered a manufacturer for purposes of this definition even if the supplier is not the actual originator or maker of the product, as long as the supplier establishes an inventory sharing network 100 with authorized merchants 120 to share products of the manufacturer 110. As another example, the manufacturer 110 that is the originator of the product may be considered a manufacturer even if another entity actual makes the product for the manufacturer 110.

As used herein, the term “merchant” is a seller of the products to customers 140. The term “authorized merchant” 120 refers to a seller of goods that are permitted by the manufacturer 110 to participate in the inventory sharing network 100. A “regular merchant” 130 refers to a seller of goods that are not permitted by the manufacturer 110 to participate in the inventory sharing network 100.

Each authorized merchant 120 may be independently owned and operated from the manufacturer 110. Being independently owned and operated means that the authorized merchant 120 is generally decentralized from the manufacturer 110 to make their own decisions regarding purchases and sales with respect to managing their inventory to sell to their customers 140. Authorized merchants 120 may also be non-exclusive, in that the authorized merchants 120 may be free to sell competing products in addition to selling the manufacturer's products. In some embodiments, one or more (but not all) authorized merchants 120 may have some type of affiliated ownership with the manufacturer 110. However, at least some of the authorized merchants 120 of the inventory sharing network 100 must be independently owned and operated from the manufacturer 110.

As a generic example, the manufacturer 110 may establish and control the inventory sharing network 100. The manufacturer 110 may authorize (e.g., permit, invite, etc.) authorized merchants 120 to participate in the inventory sharing network 100. Other regular merchant(s) 130 may not be authorized to participate in the inventory sharing network 100. The manufacturer 110 may provide products X1, X2, X3, and X4 to the authorized merchants 120. The manufacturer 110 may also provide other products X5 and X6 to regular merchant(s) 130. Each of the authorized merchants 120 and the regular merchant(s) 130 may sell their corresponding products to their customers 140. For simplicity, the authorized merchants 120 and the regular merchants 130 are described as selling products that do not overlap; however, this is not necessarily the case. In addition, each of the authorized merchants 120 are described as selling the same set of products to the customers 140; however, this is done for simplicity, and is not necessarily always the case.

The authorized merchants 120 may be independently owned and operated. The authorized merchants 120 may also be non-exclusive and permitted to sell additional products from different manufacturers to their customers 140. For example, another manufacturer (not shown) may provide products Y1 and Y2 to the authorized merchants 120. Products Y1 and Y2 may be considered to be competing products with the products of the manufacturer 110. As an example, the manufacturer 110 and the another manufacturer (not shown) may be two competing brands of skis, and products X1, X2, X3, X4, and Y1, Y2 may be different models of the skis for each respective brand.

In conventional relationships, although merchants may be non-exclusive sellers of products, merchants often have established contractual obligations with a manufacturer to only buy manufacturer's goods directly from the manufacturer. For example, a merchant may only be contractually obligated to purchase products X1, X2, X3, and X4 only from the manufacturer 110. As an example, if the manufacturer 110 is a manufacturer of skis, authorized merchants may only purchase the manufacturer's skis from the manufacturer 110 for resale to local customers, rather than purchasing the manufacturer's skis from another entity. As a result, merchants that would like to participate in conventional inventory sharing networks that are arranged by third parties, or arranged among merchants, may not be able to do so, because purchasing skis from third parties (e.g., even other merchants) would be a breach of contract with the manufacturer 110. As a non-exclusive merchant, the merchant may purchase competing skis from the competing manufacturer, and may have a similar contract in place with the competing manufacturer regarding purchasing limitations of the competitors skis.

In embodiments of the present disclosure, the authorized merchants 120 may still have contractual obligations to purchase the manufacturer's goods from the manufacturer 110; however, the inventory sharing network 100 is managed specifically by the manufacturer 110, in that the manufacturer 110 may authorize (e.g., permit, invite, etc.) certain authorized merchants 120 to participate in the inventory sharing network 100. In other words, the manufacturer 110 may provide a contractual exception for purchasing products through the inventory sharing network 100 that is approved by the manufacturer 110.

As already discussed above, the regular merchant(s) 130 may also sell products (e.g., products X5, X6) of the manufacturer 110, but may not be authorized by the manufacturer 110 to participate in the inventory sharing network 100. As a result, not all merchants that sell a manufacturer's goods may be authorized to be participants of the inventory sharing network 100. The authorized merchants 120 may be considered “key” merchants to the manufacturer. In other words, each authorized merchant 120 may be a merchant that is of particular interest to the manufacturer 110, such as being a certain type of merchant. In some embodiments, the manufacturer 110 may designate all (or a group of) specialty retailers as authorized merchants 120 as being “key” in order to promote specialty retailers according to the manufacturer's business model. In some embodiments, the manufacturer 110 may negotiate “key” status with merchants to become authorized merchants 120. In other words, authorized merchants may pay a premium (e.g., a one-time fee or a recurring fee) in order to gain admission into the manufacturer's inventory sharing network 100.

In addition, the manufacturer 110 may select “key” products that are authorized to be shared among the authorized merchants through the inventory sharing network 110. A “key” product of the manufacturer 110 may be an item of particular significance for the manufacturer 110, such as a high-end model of the product. To illustrate this point, as shown in FIG. 1A, the manufacturer 110 may permit the authorized merchants 120 to only share products X1 and X4 within the inventory sharing network 100. Thus, X1 and X4 may be considered key products, while products X2, X3, X5, X6 (and other products) may not be considered key products. In other words, in some embodiments, the authorized merchants 120 may only be permitted to share a subset of the overall set of products of the manufacturer 110.

For example, in the context of the ski industry, promoting specialty ski shops, such as might be associated with a ski resort, may be of particular importance to the manufacturer 110. This importance of the manufacturer 110 may be based on experience that specialty ski shops tend to fare better at selling the high-end skis, as opposed to large warehouse-type stores that tend to sell low-end models of their skis. In addition, specialty ski shops may perceive greater risk in stocking a greater quantity of high-end skis. Therefore, the manufacturer 110 may desire to provide special “key” status to such specialty ski shops in order to encourage the specialty ski shops to stock more inventory of their high-end skis.

Participation in the inventory sharing network 100 may provide authorized merchants 120 access a larger inventory to meet customer needs. For example, if a first authorized merchant 120 has sold its entire inventory of a particular product, the authorized merchant 120 may conventionally be limited in the methods they can pursue in obtaining more of that product, particularly if the manufacturer 110 has no further inventory on hand. By permitting authorized merchants 120 to connect with each other to share available key items, the authorized merchants 120 of the inventory sharing network 100 may have the ability to buy, sell, and ship products to other authorized merchants 120 of the inventory sharing network 100. The inventory sharing network 100 may be the authorized merchant's safety net to increase or decrease inventory volume on hand. As a result, authorized merchants 120 may be more amenable to carry greater quantities of the key products knowing that they are connected to a larger distribution network through the inventory sharing network 100. With the ability to buy or sell excess key products through the inventory sharing network 100, the authorized merchants 120 may experience increased sales, higher margins by holding price, and less inventory liquidation and product erosion.

In addition, from the manufacturer's perspective, product movement may occur where and when needed, and the end-users may potentially have the availability for any given product at their local shop, which may result in increasing brand and shop loyalty. In addition, the inventory sharing network 100 may provide the manufacturer with information regarding product movement and price, which information may provide the manufacturer 110 with knowledge of geographic regions where demand is highest, selling prices, timing of demand, among other data, which information may be limited in conventional inventory sharing networks.

As shown in FIG. 1A, the number of authorized merchants 120 are shown to be four; however, an inventory sharing network 100 may include any number of authorized merchants 120 such that a plurality of authorized merchants 120 may be permitted by the manufacturer 110 to be included within the inventory sharing network 100. In addition, as shown in FIG. 1A, the authorized merchants 120 are shown as only being connected to share inventory with adjacent authorized merchants 120. This is done merely for convenience in the illustration, and any authorized merchant 120 may be permitted to share inventory with any other authorized merchant 120 in the inventory sharing network 100.

FIG. 1B is a schematic block diagram of an e-commerce system 150 implementing the inventory sharing network 100 of FIG. 1A. The e-commerce system 150 includes an access server 102 coupled to a shared inventory database 104. The manufacturer 110 and the authorized merchants 120 couple with the access server 102, such that each of the manufacturer 110 and the authorized merchants 120 has access to data of the shared inventory database 104. For example, each of the manufacturer 110 and the authorized merchants 120 may access the access server 102 over a network (e.g., the Internet), which may provide access from any electronic device coupled thereto.

The access server 102 includes an e-commerce platform that organizes the shared inventory database 104, generates displays for the participants of the inventory sharing network 100, receives inputs, executes inventory sharing transactions, and reports information to the manufacturer 110. The e-commerce platform may be a software module stored on a computer readable medium, having instructions for managing the various operations of the inventory sharing network 100. Thus, the access server 102 may include a processor 103 that executes the software module.

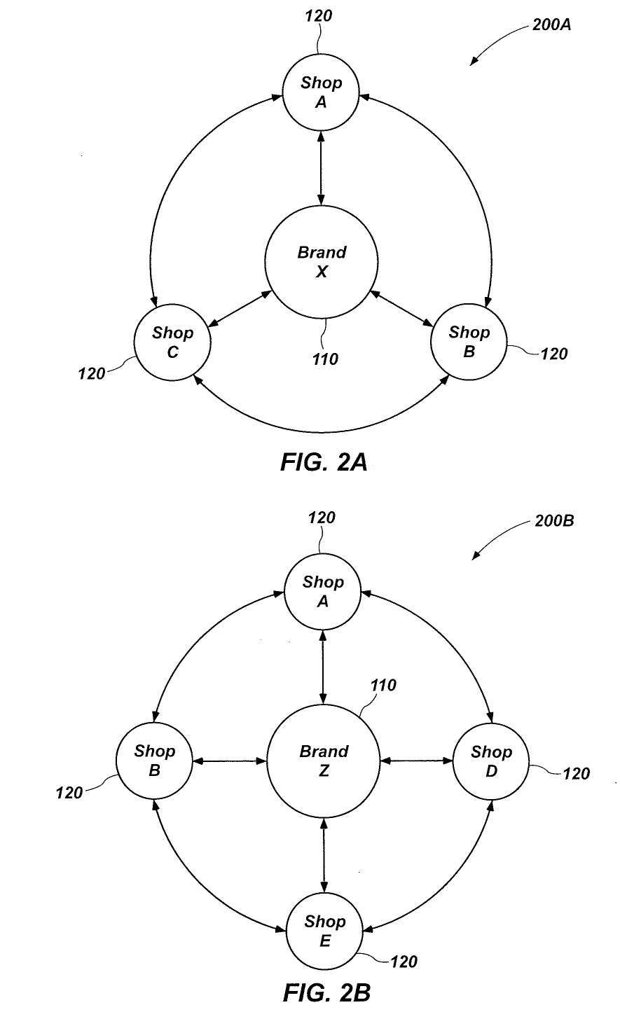

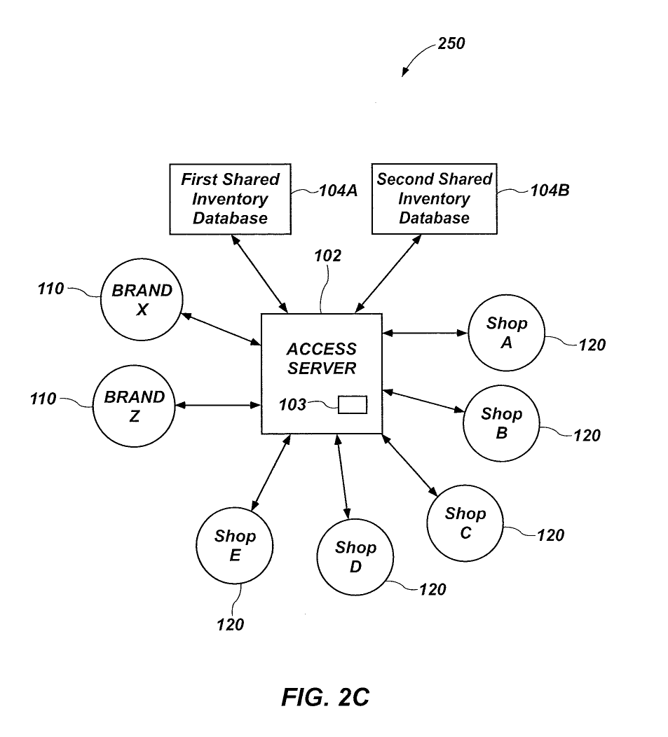

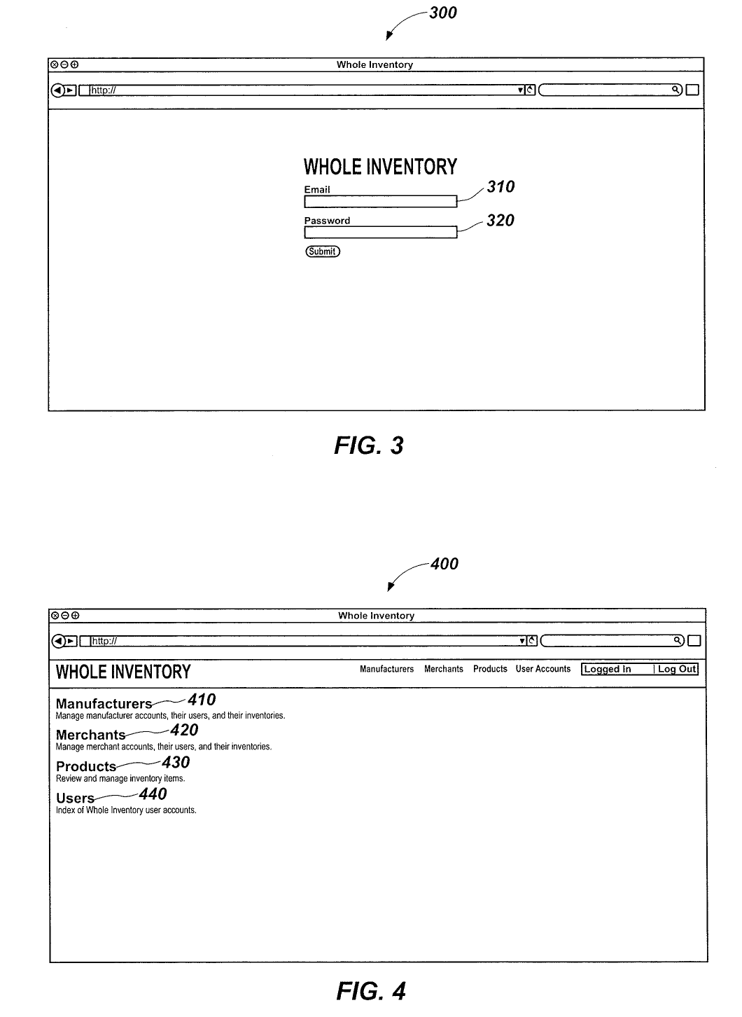

FIGS. 2A, 2B, and 2C offer more specific examples of inventory sharing network 200A, 200B, and an e-commerce system 250 than those of FIGS. 1A and 1B. In particular, FIG. 2A is an inventory sharing network 200A for “Brand X” (a manufacturer 110) having “Shop A,” “Shop B,” and “Shop C,” as authorized merchants 120. FIG. 2B is an inventory network 200B for “Brand Z” (a manufacturer 110) having “Shop A,” “Shop B,” “Shop D,” and “Shop E,” as authorized merchants 120. FIG. 2C shows a schematic block diagram for an e-commerce system 250 that manages a plurality of different shared inventory networks 200A, 200B. These examples for the manufacturers 110 and the authorized merchants 120 are provided in FIGS. 2A, 2B, and 2C as they will further be used to discuss the screenshots of FIGS. 3 through 9. Customers 140 and other regular merchants 130 are not shown in FIGS. 2A, 2B, and 2C for convenience; however, such relationships may exist as discussed in the generic inventory sharing network 100 of FIGS. 1A and 1B.

The inventory sharing networks 200A, 200B are controlled by their respective manufacturer 110. For example, inventory sharing network 200A may be established under the direction of Brand X to share the selected products of Brand X, while inventory sharing network 200B may be established under the direction of Brand Y to share the selected products of Brand Y.

Referring specifically to FIGS. 2A and 2B, it should be noted that Shop A is an authorized merchant 120 for both the inventory sharing networks 200A, 200B. In other words, Shop A may share products of Brand X with Shops B and C, and share products of the Brand Z with Shops D, E, and F. Thus, an authorized merchant 120 may participate in a plurality of different inventory sharing networks for a plurality of different manufacturers 110. While Shop A is the only common authorized merchant 120 shown between inventory sharing networks 200A and 200B, that does not have to be the case. If the focus of Shop A and Shop B is similar, it is likely that they each carry similar products from many of the same manufacturers, and could be part of several of the same inventory sharing networks. As each inventory sharing network is controlled by a particular manufacturer 110, the authorization for their own inventory sharing network may be determined independently of the authorization for another inventory sharing network. In other words, Brand X may authorize whichever authorized merchants 120 are determined to be key to Brand X, which may be a completely separate determination from Brand Z making its own determination of its key authorized merchants 120.

Referring specifically to FIG. 2C, the access server 102 may include an e-commerce platform that manages a plurality of different inventory sharing networks. For example, each of the authorized merchants 120 (i.e., Shops A-F) and the manufacturers 110 (i.e., Brand X, Brand Z) may access the access server 102. The access server 102 may be coupled to a first shared inventory database 104A and a second shared inventory database 104B. The first shared inventory database 104A may correspond to the first shared inventory network 200A (controlled by Brand X), and the second shared inventory database 104B may correspond to the second shared inventory network 200B (controlled by Brand Z). The access server 102 may be configured to only provide access to members of the respective shared inventory network 200A, 200B, with access to the corresponding shared inventory database 104A, 104B. In other words, the access server 102 may be configured to provide Brand X, Shop A, Shop B, and Shop C access to the first shared inventory database 104A, and Brand Z, Shop A, Shop D, and Shop E access to the second shared inventory database 104B.

FIGS. 3 through 10 are screenshots of various graphical user interfaces that may be generated by the e-commerce system 250 of FIG. 2C. The various graphical user interfaces are shown herein as examples, and the particulars thereof are not intended to be limiting as to a specific configuration or display, unless specifically described or claimed as such. At least some of the graphical user interfaces may provide authorized merchants 120 with an interface to access the access server 102, edit their product listings for inventory sharing, and enter inventory sharing transactions with other authorized merchants 120. In other words, access to the inventory sharing networks 200A, 200B through the access server 102 provides authorized merchants 120 with access to a potentially global inventory of key products in which the authorized merchants 120 may buy and sell the key products from each other. At least some of the graphical user interfaces may also be viewed by the manufacturer 110 for similar purposes, and for additional purposes, such as obtaining reporting information regarding the inventory sharing transactions executed within their inventory sharing network 200A. For example, Brand X may have access to view inventory sharing transaction information (e.g., price, product movement) related to its inventory sharing network 200A, but not the information related to Brand Z's inventory sharing network 200B.

Referring specifically to FIG. 3, FIG. 3 shows a log-in screen 300 that may be used to gain access to the access server 102 and interact with the inventory sharing networks 200A, 200B. The log-in process may include a user inputting a user identification 310 (e.g., email address, username, etc.) and an associated password 320 to access their user account information. Each user account may be granted certain access privileges to one or more of the inventory sharing networks 200A, 200B.

For example, FIG. 4 shows an introduction screen 400 that shows examples of different areas that users may have access to view or edit. If the user is an administrator of the overall e-commerce system 250, the user may be able to access each of the different areas and their associated information. For example, an administrator of the system may be able to access information related to a manufacturer area 410, merchant area 420, product area 430, and user area 440. The manufacturer area 410 may provide an administrator the ability to view and manage manufacturer accounts, their users (i.e., individuals within the manufacturer who have user accounts), and the inventory items of the manufacturer. The merchant area 420 may provide an administrator the ability to view and manage merchant accounts, their users (i.e., individuals within the merchant who have user accounts), and the inventory items of the merchants. The product area 430 may provide an administrator the ability to view and manage inventory items listed in the e-commerce system 250 (e.g., from all inventory sharing networks 200A, 200B supported by the e-commerce system 250). The user area 440 may provide an administrator the ability to view and manage the entire list of user accounts that have some type of access privileges to the inventory sharing networks 200A, 200B, whether they be associated with a manufacturer 110, an authorized merchant 120, or some other entity providing a user account to the e-commerce system 250.

FIG. 5 shows a manufacturer screen 500 that may be accessible to a user when the user is classified as a manufacturer 110. As discussed above, the examples shown in FIG. 5 correspond to the inventory sharing networks 200A, 200B, and the e-commerce system 250 of FIGS. 2A, 2B, and 2C. The manufacturer 110 shown for this example is Brand X, which controls the inventory sharing network 200A. As a result, only authorized merchants 120 of Brand X may share key products of Brand X through the inventory sharing network 200A.

The manufacturer screen 500 further includes a product list 530. The product list 530 corresponds to the key products that the manufacturer 110 permits to be shared within the inventory sharing network 200A. As discussed above, the key products may be a subset of the overall products supplied by the manufacturer 110. For example, the key products may be chosen by the manufacturer 110 to be a particular type of products (e.g., high-end products). Each product within the product list 530 may include a general description 532, such as “29” Carbon Wheels/Ceramic Bearings.” Each product within the product list 530 may further include additional descriptive information 534, such as size, year, manufacturer's suggested retail price (MSRP), and other information (e.g., color, shape, etc.) that may depend on the specific type of product. The manufacturer 110 may be able to add a product to the product list 530 by the user selecting a button 531, which may prompt the user to enter the appropriate information regarding the product to be added. Therefore, the manufacturer 110 may have control over which products are permitted to be shared within the inventory sharing network 200A.

The manufacturer screen 500 may further include an authorized merchant list 520. The authorized merchant list 520 in this example includes Shop A, Shop B, and Shop C as authorized merchants 120 of Brand X. As discussed above, the authorized merchants 120 may be a sub-set of the entire set of merchants that carry the manufacturer's products. For example, the authorized merchants 120 may be a particular type of merchant (e.g., specialty retail stores) of interest to the manufacturer 110. The manufacturer 110 may be able to add an authorized merchant 110 to the authorized merchant list 520 by the user selecting a button 521, which may prompt the user to enter the appropriate information regarding the authorized merchant 120 to be added. Therefore, the manufacturer 110 may have control over which merchants the manufacturer 110 designates as authorized merchants 120 to participate in the inventory sharing network 200A.

The manufacturer screen 500 may further include information regarding the manufacturer 110, such as a user account list 540 and general manufacturer information 550. The user account list 540 includes the names of users associated with the manufacturer 110 that have user accounts, and may access the manufacturer screen 500. As shown in FIG. 5, “Sally Smith” has been assigned a user account, and is listed as the primary contact for the manufacturer 110 “Brand X.” General manufacturer information 550 may include information such as website, phone number, billing and shipping addresses, tax identification number, and other relevant information.

The manufacturer 110 may be in control of the decision making to edit information regarding the manufacturer 110. For example, the manufacturer 110 may edit existing product information, authorized merchant information, user account information, and general manufacturer information. In addition, the manufacturer 110 may elect to have user accounts deleted, or key products removed, and authorized merchants 120 removed from the inventory sharing network 200A. In some embodiments, the administrator of the e-commerce system 250 may make the edits to the various accounts according to the direction of the manufacturer 110. For example, the manufacturer 110 may notify the administrator of the e-commerce system 250 of desired changes (e.g., via email, phone, etc.). In some embodiments, the manufacturer 110 may be provided with access to make such edits directly into the e-commerce system 250. The user that makes the desired edits may select a button 551, which may prompt the user to make edits to the information displayed in the manufacturer screen 500.

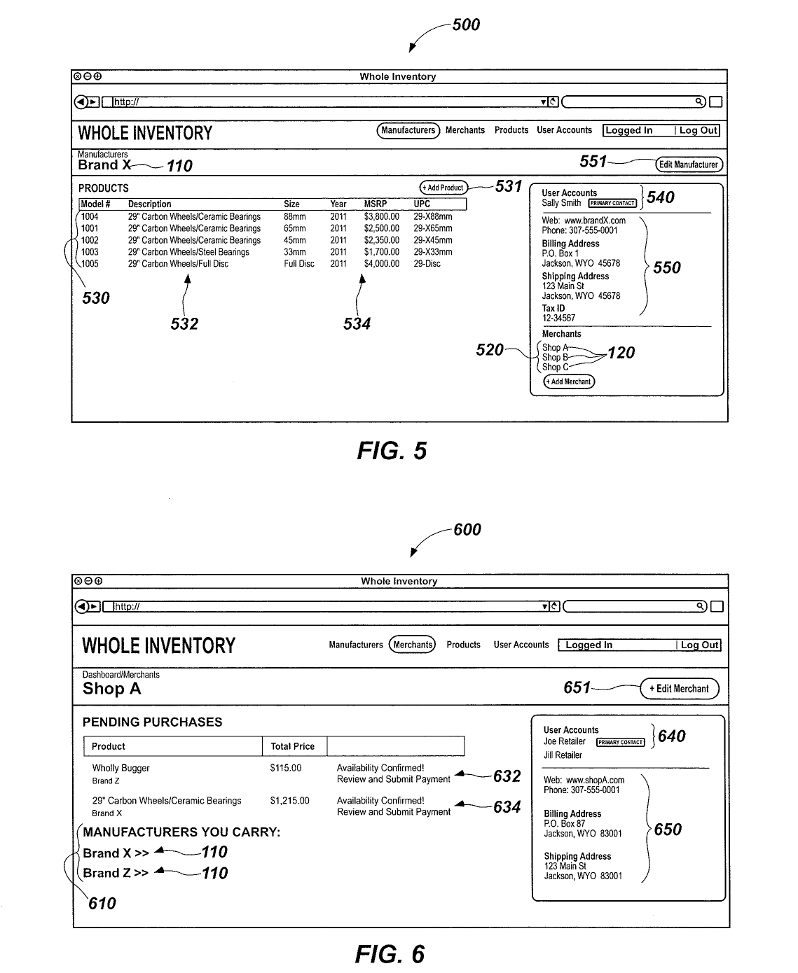

FIG. 6 shows an authorized merchant screen 600 that may be accessible to a user when the user is classified as an authorized merchant 120. In this example, the authorized merchant 120 is “Shop A.” The authorized merchant screen 600 may include a manufacturer list 610 associated with the authorized merchant 120. The manufacturer list 610 may include one or more manufacturers 110 which the authorized merchant 120 is a participant in their inventory sharing network. In this example, Brand X and Brand Z are manufacturers 110 associated with Shop A. In other words, Shop A is a participant in a plurality of inventory networks 200A, 200B. In the first inventory sharing network 200A, Shop A may be permitted to share key products from Brand X with other authorized merchants (e.g., Shops B, C; see FIG. 2A) of Brand X. In the second inventory sharing network 200B, Shop A may be permitted to share key products from Brand Z with other authorized merchants (e.g., Shops B, D, E; see FIG. 2B) of Brand Z. In other words, the e-commerce system 250 may provide the authorized merchant (e.g., Shop A) with the ability to access a plurality of different inventory sharing networks 200A, 200B through an integrated interface. Each individual inventory sharing network 200A, 200B may correspond to different manufacturers 110.

In some embodiments, individual manufacturers 110 may establish and control a plurality of different inventory sharing networks that may include one or more different authorized merchants 120 or key products. The e-commerce system 250 may also be configured to manage such inventory sharing networks, and provide an integrated interface for the manufacturer 110 to access and manage its plurality of inventory sharing networks. In other words, the manufacturer 110 may control different inventory sharing networks for different authorized merchants 120 that are authorized to sell different products on each inventory sharing network. For example, the manufacturer 110 may control a first inventory sharing network for authorized merchants 120 selling high-end products, and control a second inventory sharing network for authorized merchants 120 selling low-end products. As a result, in some embodiments, all products of the manufacturer 110 may be included in at least one inventory sharing network controlled by the manufacturer 110. The e-commerce platform 250 may provide a common interface to access each of these different inventory sharing networks.

Referring again to FIG. 6, the authorized merchant screen 600 further includes pending purchase information 630. The pending purchase information 630 may include purchases for all inventory sharing networks 200A, 200B that the authorized merchant 120 is a participant in. For example, a first pending purchase entry 632 may be a product (e.g., Wholly Bugger) from the inventory sharing network 200B for Brand Z, and a second pending purchase entry 634 may be for a product (e.g., Carbon Wheels) from the inventory sharing network 200A for Brand X. The pending purchases may be reviewed, confirmed, and executed by the authorized merchant 120 for the plurality of inventory sharing networks 200A, 200B from the authorized merchant screen 600.

The authorized merchant screen 600 may further include a user account list 640. The user account list 640 includes the names of users associated with the authorized merchant 120 that have user accounts, and may access the authorized merchant screen 600. As shown in FIG. 6, “Joe Retailer” and “Jill Retailer” have been assigned a user account, with Joe Retailer being listed as the primary contact for the authorized merchant 120 “Shop A.”

The authorized merchant screen 600 may further include general authorized merchant information 650. Such general authorized merchant information 650 may include information such as website, phone number, billing and shipping addresses, and other relevant information.

The authorized merchant 120 may edit information for the authorized merchant 120 by the user selecting a button 651, which may prompt the user to make edits to the information displayed in the authorized merchant screen 600. For example, the authorized merchant 120 may edit user account information from the user account list 640, and the general authorized merchant information 650.

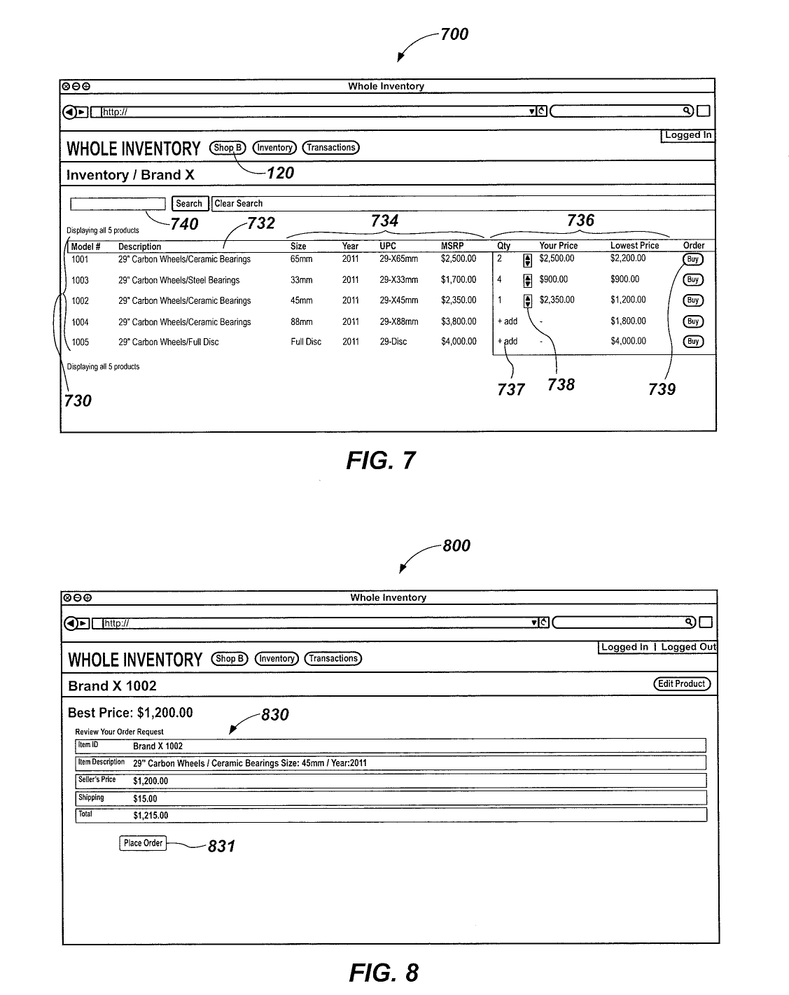

FIG. 7 shows a product screen 700 that may be accessible to a user when the user is classified as an authorized merchant 120. The authorized merchant 120 in this example is Shop B. The product screen 700 includes a product list 730. The product list 730 corresponds to the key products designated by a particular manufacturer 110. In this example, the manufacturer is Brand X. For example, this product screen 700 may be opened upon selection of Brand X on the authorized merchant screen 600 of FIG. 6. The product list 730 also corresponds to the key products selected by the manufacturer 110 (Brand X) through the manufacturer screen 500 of FIG. 5. As a result, the general product description 732 and the additional descriptive information 734 may include the same information as provided by the manufacturer 110 through its manufacturer screen 500. As this information is determined by the manufacturer 110, the general product description 732 and the additional descriptive information 734 may not be edited or deleted by the authorized merchant 120. The product screen 700 may further include a search feature 740, which may be helpful for locating a particular product among a large product list 730.

The product list 730 may further include inventory sharing information 736, which may be edited by the authorized merchants 120. Such inventory sharing information 736 includes the information that is provided to the other authorized merchants 120 in the inventory sharing network 200A. For example, the authorized merchant 120 may have listed the quantity (“Qty”) of each product of the manufacturer 110 that the authorized merchant 120 desires to make available, as well as the price (“Your Price”) that the authorized merchant 120 is willing to accept from another authorized merchant 120. For example, Shop B has indicated that they are willing to share the product for model #1001, that they have two available to share, and that they are willing to accept $2,500 for the product from another authorized merchant 120 in the inventory sharing network 200A. As shown in FIG. 7, the offer price to the inventory sharing network 200A may be less than the MSRP provided by the manufacturer 110. The inventory sharing information 736 includes inputs 737, 738 for the authorized merchant 120 to manage its own inventory that the authorized merchant 120 desires to make available to the inventory sharing network 200A. For example, the input 737 may add a new entry for a product not previously listed. Input 738 may permit the authorized merchant 120 to increase and decrease the quantity of each product. For example, the authorized merchant 120 may manually increase or decrease the quantity of each product as their own in-store inventory is sold to customers 140 outside of the inventory sharing network 200A. The authorized merchant may choose to manually increase or decrease the quantity of each product list through the inventory sharing network 200A based solely on the desire to offer more or fewer products for sale through the inventory sharing network 200A. If products are sold through the inventory sharing network 200A, the e-commerce system 250 may automatically update the inventory listings and decrease the quantity of that product offered by the selling authorized merchant 120.

Product price may be edited through an input (not shown), or through selecting the price listed (acting as a hyperlink) and entering a new price. Therefore, each authorized merchant 120 in the inventory sharing network 200A may be free to choose the price at which the product is offered to the other authorized merchants 120 in the inventory sharing network 200A. In some embodiments, the e-commerce system 250 may require the authorized merchant 120 to verify the quantity and price offered through the inventory sharing network 200A after a predetermined period of inactivity, which may help ensure that listings are kept up-to-date. If the listing is not verified within the predetermined timeframe, the listings by the inactive authorized merchant 120 may be removed in order to reduce errors in making inventory sharing transactions on products that are no longer available (as products may have been sold outside of the inventory sharing network to regular customers 140). Thus, the shared inventory database 104 may be updated in response to at least one of the following actions: an inventory sharing transaction through the inventory sharing network 200A, 200B, a manual update by an authorized merchant 120 to update a desired quantity or offer price for the products available, and a periodic required update issued to the authorized merchant 120 to verify information of the products available.

The product screen 700 may further include a buy button 739 for the authorized merchant 120 to purchase from another authorized merchant 120 in the inventory sharing network 200A. In some embodiments, a best price (“Lowest Price”) may also be listed to indicate the lowest amount offered for each product by other authorized merchants 120 of the inventory sharing network 200A. The authorized merchant 120 may also have access to price histories of each product to see recent sale prices of related inventory sharing transactions. Selecting the buy button 739 may initiate an inventory sharing transaction, such as by opening an order screen. If a buying authorized merchant 120 purchases a product that has been listed by a selling authorized merchant 120, the selling authorized merchant 120 shall be obligated to sell that product for the price listed. Penalties may be imposed if the product is no longer available.

FIG. 8 shows an order screen 800 that may be accessible to a user when the user desires to purchase a product from one of the authorized merchants 120 of the inventory sharing network 200A. The order screen 800 shows the details 830 of the inventory sharing transaction. For example, the seller's price of $1,200 is shown for the Brand X product having a product number “1002.” The seller's price for this inventory sharing transaction is the lowest price available from all authorized merchants 120 offering this particular product for sale through the inventory sharing network 200A. In other words, the buying authorized merchant 120 is offered the best price for the product among all listings for that product. In some embodiments, the buying authorized merchant 120 may not be shown the identity or even the location of the selling authorized merchant 120 prior to the inventory sharing transaction being confirmed.

Shipping costs may also be added to the total cost for the buying authorized merchant 120. For example, shipping may be arranged for through the e-commerce system 250 through a shipping agency (e.g., U.S. Postal Service, FedEx, UPS, etc.) and pre-paid for by the buying authorized merchant 120. As a result, when the selling authorized merchant 120 receives confirmation that the inventory sharing transaction has occurred, the selling authorized 120 merchant may simply print out a pre-paid shipping label to use during shipping. The shipping arrangements may be selected by the selling authorized merchant 120 upon entering the inventory sharing network 200A. Other shipping arrangements may be used as well, including seller-paid shipping, manufacturer-paid shipping, and so on. Different shipping methods, speeds, and corresponding prices may be offered.

When the order is placed through a place order button 831, the buying authorized merchant 120 may be debited for the purchase. Payment may occur through an third party payment service (e.g., PayPal), through a credit/debit payment collected by the administrator of the e-commerce system 250, through a pre-established deposit account established with the administrator of the e-commerce system 250, or through other methods. The buying authorized merchant 120 may have the product shipped to their store to sell or provide to a customer 140. In some embodiments, the specific customer 140 may already be identified, and the buying authorized merchant 120 may have the selling authorized merchant 120 shipped directly to the specific customer 140. In some embodiments, the buying authorized merchant 120 may not have a specific customer 140, and may merely desire to add to their inventory to offer to their customers for a product that is in demand. At the end of the inventory sharing transaction, notification (e.g., via email) may be sent to interested parties (e.g., buying merchant, selling authorized merchant, manufacturer, administrator, etc.) to provide status and other details of the inventory sharing transaction.

After shipment, the administrator of the e-commerce system 250 may release the funds to the selling authorized merchant 120 (e.g., through a third party company such as PayPal). The administrator of the e-commerce system 250 may reduce the final amount by a set fee (i.e., commission) that may be a flat fee, a percentage, or some other commission rate. The administrator of the e-commerce system 250 may generate revenue through other methods, such as charging a membership fee (e.g., monthly, yearly, etc.) rather than, or in addition to, fees collected from individual inventory sharing transactions. Such membership fees may be charged to manufacturers 110, authorized merchants 120, or both. In some embodiments, revenue may be generated through other methods, such as advertising. In some embodiments, the administrator of the e-commerce system 250 may be the manufacturer 110 itself rather than a third party company.

In some embodiments, the manufacturer 110 may be authorized to purchase products from the inventory sharing network 200A. In other words, the manufacturer 110 may have some, or all, of the rights and privileges of the authorized merchants 120. For example, in some embodiments, the manufacturer 110 may engage in selling products directly to customers in addition to using merchants. In such an embodiment, the manufacturer 110 may receive an order to fill from its own website that the manufacturer 110 cannot fill. In order to fill and satisfy customer demand, the manufacturer 110 may be able to find the desired product through the inventory sharing network 200A rather than losing a potential sale.

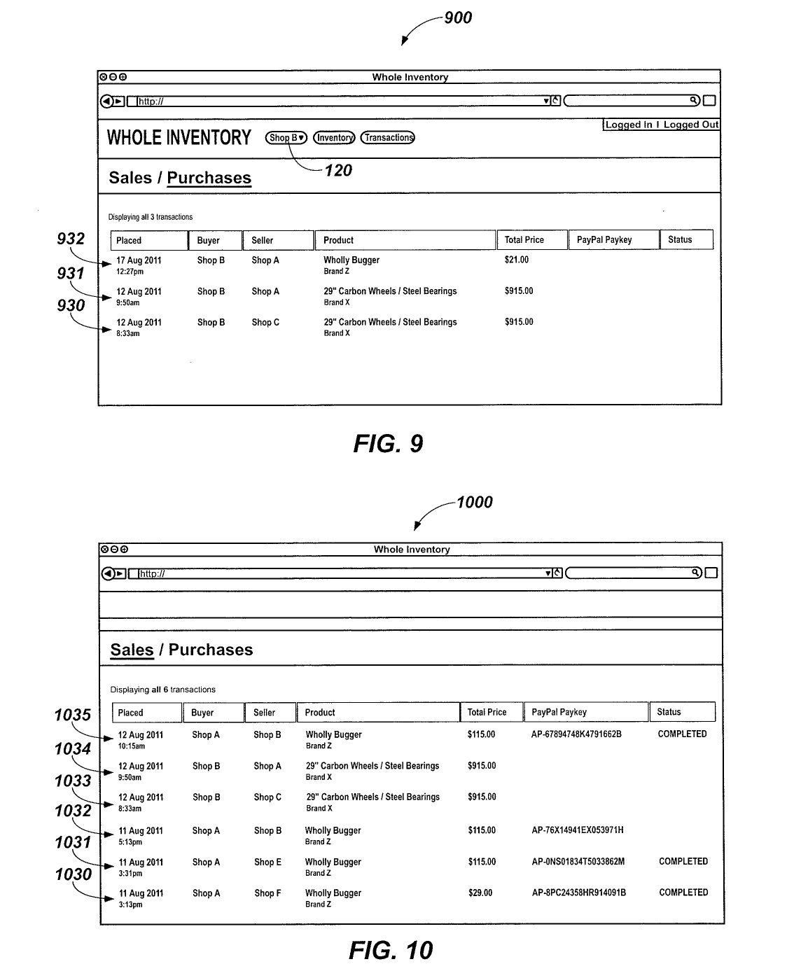

FIG. 9 is a purchase log screen 900 that may be accessible to authorized merchants 120 to view the status of purchases they have made. The purchase log screen 900 may include purchases 930, 931, 932 that are associated with the various inventory sharing networks 200A, 200B they are invited to participate in. For example, purchases 930, 931 are associated with inventory sharing network 200A controlled by Brand X, while purchase 932 is associated with inventory sharing network 200B controlled by Brand Z. Each purchase 930, 931, 932 listed may include information such as the time and date of placing the order, the name of the buying authorized merchant 120, the name of the selling authorized merchant 120, the name of the product and manufacturer 110, the purchase price, transaction numbers (e.g., PayPalkey), status, and other information that may be considered desirable.

FIG. 10 is a transaction log screen 1000 that may include transaction information of transactions executed through the e-commerce system 250. Such a transaction log may be accessible by the administrator of the e-commerce system 250, as the transaction log screen 1000 includes information for more than one inventory sharing network 200A, 200B. For example, the transaction log screen 1000 shows sales 1033, 1034 that have been made for inventory sharing network 200A controlled by Brand X, and sales 1030, 1031, 1032, 1035 that have been made for inventory sharing network 200B controlled by Brand Z. Each sale 1030, 1031, 1032, 1033, 1034, 1035 listed may include information such as the time and date of placing the order, the name of the buying authorized merchant 120, the name of the selling authorized merchant 120, the name of the product and manufacturer 110, the purchase price, transaction numbers (e.g., PayPalkey), status, and other information that may be considered desirable.

Authorized merchants 120 may also have access to sales information for sales they have made. Sales information may include similar information as the purchase information. Thus, the authorized merchants 120 may have access to a similar screen as the transaction log screen 1000; however, sales information may be limited to only those entries in which the authorized merchant 120 is a seller.

Similarly, manufacturers 110 may have access to purchase and sales information for inventory transactions in their inventory sharing networks of which the manufacturer 110 has control. Thus, the manufacturers 110 may have access to similar screens as the purchase log screen 900 of FIG. 9, and the transaction log screen 1000 of FIG. 10. The manufacturer 110 may further be provided additional information for each inventory sharing transaction on their inventory sharing network. For example, such reporting information may include information such as key products sold, selling price, price history, product movement by location (e.g., location or region of buyer and seller), shelf life of product prior to the inventory sharing transaction, and other related information that may be valuable for the manufacturer 110 in reducing the guess work for inventory aging of their key products. As a result, the manufacturer 110 may have more control in dictating product direction and market locations. Accurate point of sale reporting will also aid in more focused advertising geographically as well as in making decisions regarding production volume and timing.

### CONCLUSION

An embodiment of the present disclosure includes an e-commerce system. The e-commerce system comprises a shared inventory database for storing inventory data, and an access server coupled to the shared inventory database. The access server is configured to be accessed by a plurality of authorized merchants to manage entries for inventory items within the shared inventory database for products available to be shared among the plurality of authorized merchants of an inventory sharing network. The plurality of authorized merchants are independently owned and operated from a manufacturer of the goods and are non-exclusive merchants permitted to sell competing goods of the manufacturer.

Another embodiment of the present disclosure includes an inventory sharing network, comprising a manufacturer of a plurality of manufacturer's products, and a plurality of authorized merchants that are independently owned and operated from the manufacturer as a non-exclusive seller of products, and contractually obligated to purchase the plurality of manufacturer's products only from the manufacturer. The plurality of authorized merchants are selected to participate in an inventory sharing network by the manufacturer that permits the plurality of authorized merchants to additionally purchase the plurality of manufacturer's products from each other.

Yet another embodiment of the present disclosure includes a method for sharing inventory among authorized merchants. The method comprises executing an inventory sharing transaction between authorized merchants authorized by a manufacturer to join a private inventory sharing network. The inventory sharing transaction involves one of a plurality of key products selected by the manufacturer to be shared within the inventory sharing network.

While the invention is susceptible to various modifications and implementation in alternative forms, specific embodiments have been shown by way of examples in the drawings and have been described in detail herein. However, it should be understood that the invention is not intended to be limited to the particular forms disclosed. Rather, the invention includes all modifications, equivalents, and alternatives falling within the scope of the following appended claims and their legal equivalents.

What is claimed is:

1. An e-commerce system, comprising:
a shared inventory database for storing inventory data; and
an access server coupled to the shared inventory database, wherein the access server is configured to be accessed by a plurality of authorized merchants to manage entries for inventory items within the shared inventory database for products available to be shared among the plurality of authorized merchants of an inventory sharing network, wherein the plurality of authorized merchants are independently owned and operated from a manufacturer of the products and are non-exclusive merchants permitted to sell competing products of the manufacturer.

2. The e-commerce system of claim 1, wherein the shared inventory database is updated in response to at least one of the following actions:
an inventory sharing transaction through the inventory sharing network;
a manual update by an authorized merchant of the plurality of authorized merchants to update a desired quantity of the products available; and
a periodic required update issued to the authorized merchant to verify information of the products available.

3. The e-commerce system of claim 1, wherein the access server is further configured to permit the plurality of authorized merchants to share the products of the manufacturer and not the competing products of the manufacturer.

4. The e-commerce system of claim 1, wherein the products that may be shared within the inventory sharing network are determined by the manufacturer of the products.

5. The e-commerce system of claim 1, wherein the access server is configured to be accessed through an e-commerce platform executing a graphical user interface configured to communicate with the access server over a network to display the inventory data and to update the entries in the shared inventory database.

6. The e-commerce system of claim 5, wherein the access server is configured to manage a plurality of inventory sharing networks controlled by a plurality of different manufacturers.

7. The e-commerce system of claim 6, wherein the e-commerce platform is configured to provide at least one authorized merchant of the plurality with access to the plurality of inventory sharing networks if authorized by the plurality of different manufacturers.

8. The e-commerce system of claim 7, wherein the graphical user interface is an integrated interface that provides the access to the plurality of inventory sharing networks for the at least one authorized merchant of the plurality.

9. The e-commerce system of claim 7, wherein the e-commerce platform is managed by a third party administrator that generates revenue from administering the e-commerce platform.

10. An inventory sharing network, comprising:
a manufacturer of a plurality of manufacturer's products; and
a plurality of authorized merchants that are independently owned and operated from the manufacturer as non-exclusive sellers of products, and contractually obligated to purchase the plurality of manufacturer's products only from the manufacturer, wherein the plurality of authorized merchants are selected to participate in an inventory sharing network by the manufacturer that permits the plurality of authorized merchants to additionally purchase the plurality of manufacturer's products from each other.

11. The inventory sharing network of claim 10, wherein the plurality of authorized merchants are free to select a quantity and a price to offer for sale the plurality of manufacturer's products to each other.

12. The inventory sharing network of claim 10, wherein the plurality of manufacturer's products that are permitted to be shared within the inventory sharing network are key products selected by the manufacturer of the manufacturer's entire product line.

13. The inventory sharing network of claim 12, wherein the key products are high-end products of the manufacturer.

14. The inventory sharing network of claim 10, wherein the plurality of authorized merchants are key merchants selected by the manufacturer of the manufacturer's entire set of merchants.

15. The inventory sharing network of claim 14, wherein the key merchants are specialty retail stores.

16. The inventory sharing network of claim 10, wherein the manufacturer is a maker of the plurality of manufacturer's products.

17. The inventory sharing network of claim 10, wherein the inventory sharing network is implemented by an e-commerce platform stored on an access server that manages access to an inventory sharing database and display of related information.

18. A method for sharing inventory among authorized merchants, the method comprising executing an inventory sharing transaction between authorized merchants authorized by a manufacturer to join a private inventory sharing network, wherein the inventory sharing transaction involves one of a plurality of key products selected by the manufacturer to be shared within the private inventory sharing network.

19. The method of claim 18, wherein executing the inventory sharing transaction includes a buying authorized merchant being offered a best price for a corresponding key product of the plurality from among the authorized merchants.

20. The method of claim 19, wherein executing the inventory sharing transaction includes informing the buying authorized merchant an identification of a selling authorized merchant only until after the inventory sharing transaction is confirmed.

21. The method of claim 18, further comprising reporting purchase information back to the manufacturer after the inventory sharing transaction is confirmed, wherein purchase information includes at least one of a sale price, key product movement locations, and shelf life of the key product prior to the inventory sharing transaction.

22. The method of claim 19, further comprising shipping the corresponding key product from a corresponding key product from a selling authorized merchant to a buying authorized merchant.
